(19) United States
(12) Patent Application Publication
(10) Pub. No.: US 2026/0061676 A1
(43) Pub. Date: Mar. 5, 2026

(54) Method for Connecting Extruded Flexible Components to Molded Parts

(71) Applicant: Jes Tougaard GRAM, George Town (KY)

(72) Inventor: Jes Tougaard GRAM, George Town (KY)

(73) Assignee: Gram Medical Inc., Scottsdale, AZ (US)

(21) Appl. No.: 19/320,048

(22) Filed: Sep. 5, 2025

Related U.S. Application Data
(60) Provisional application No. 63/691,248, filed on Sep. 5, 2024.

(51) Int. Cl. B29C 45/14; B29C 45/76; B29K 83/00; B29L 23/00

(52) U.S. Cl. CPC B29C 45/14311; B29C 45/14598; B29C 45/76; B29C 2045/14327; B29C 2945/76167; B29C 2945/76474; B29C 2945/76488; B29K 2083/00; B29L 2023/22

(57) ABSTRACT

The present invention relates to a method of introducing extruded flexible profiles and/or extruded flexible substrates, like foils or thermoformed foils/sheets, into an injection mold for the overmolding of at least one area of the single and/or multi-layer flexible extruded part. Making the over-molded extruded profile/foil a pre-assembly for an improved connection/assembly in terms of strength and sealing capability, as well as for a chemical and/or mechanical connection to a following injection molded part and/or introduction to a subsequent over-molding process.

### FIELD OF INVENTION

The present invention relates to a method for overmolding areas of extruded flexible parts that enables better accuracy, finish, assembly, separation control and strength between extruded flexible profiles and foils, such as single or multi-layer tubes and/or single or multi-layer thermoformed flexible foils that connect to an injection molded part and/or are introduced to a following injection overmolding process.

More particularly, the present invention relates to a method of introducing extruded flexible profiles and/or extruded flexible substrates like foils or thermoformed foils/sheets into an injection mold for the overmolding of at least one area of the single and/or multi-layer flexible extruded part.

Making the overmolded extruded profile/foil a pre-assembly for an improved connection/assembly in strength and sealing capability as well as chemical and/or mechanical connection being connected to a following injection molded part and/or introduced to a following overmolding process.

### BACKGROUND OF THE INVENTION

Extruded flexible tubing, profiles and/or extruded flexible foils are made from an open-ended molding process with limited accuracy and limited geometries given that it needs to be cut at a given length to be removed from the extrusion mold and in most cases again e.g. when cut into product size and/or thermoformed in a secondary process leaving ruff exposed edges from the cutting and/or stamping process.

The geometries of extrusion, that is, an open-ended molding process, are limited to 2D dimensions compared to the 3D geometries of injection molded parts that are molded in a closed cavity, enabling more complex geometries, surfaces, and accurate measurements. Still, through an overmolding process according to the invention, many of the extrusion limitations can be fixed.

Extruded flexible tubing, profiles, and/or extruded flexible foils are used in many different applications and can be made in multilayer and/or multi-material configuration and sometimes also with reinforcement elements applied/added during the extrusion process. E.g., a mesh in a garden hose for strength or a multilayer in foils and tubing for barrier, strength, and surface finish.

Thermoforming is a manufacturing process where a plastic sheet is heated to a pliable forming temperature, formed into a specific shape in a mold, and trimmed to create a usable product. The sheet, or “foil” when referring to thinner gauges and certain material types, is heated in an oven to a high-enough temperature that permits it to be stretched into or onto a mold and cooled to a finished shape. Its simplified version is vacuum forming.

In its simplest form, a small tabletop or lab-sized machine can be used to heat small cut sections of plastic sheet and stretch them over a mold using a vacuum. This method is often used for sample and prototype parts. In complex and high-volume applications, very large production machines are utilized to heat and form the plastic sheet and trim the formed parts from the sheet in a continuous high-speed process, and can produce many thousands of finished parts per hour, depending on the machine, mold size, and the size of the parts being formed.

Welded flexible bags for fluids from extruded flexible foils and sheets in both single and multilayer are often used in the medical industry where PVC and EVA are some of the chosen grades due to their good welding properties that enables an easy connection of fitments, connectors and other attachments e.g. used for blood or liquid IV bags administering fluids to patients or colostomy bags for human waste leaving the body. Some of the downsides of these materials is how poorly they degrade and recycle. They also have their rough edges where they have been cut.

It is a known technique to use extruded flexible decorated foils for in-mold labeling in an overmolding process, but the label becomes part of the injection molded part do not extend outside the molding cavity. In the cavity, the thin flexible foil and any rough edges are embedded into the plastic part when molten plastic is introduced, and the foil is for decoration purposes only and has no structural or mechanical purpose and doesn't extend outside the injection molding area.

Extruded flexible profiles and foils has the advantage of wall thickness and length compared to injection molded parts where wall thickness and length are limited due to the constrictions of the mold where e.g. cavity size, gate, flow, core length, wall thickness, sink, cycle time, ejection and clamp force are some of the limitations in having closed cavities in the injection molding process compared to the extrusion process that's open ended.

Currently, most connection points between flexible tubing products and injection molded parts are done by pressing a connector stud into the end of a flexible tubing product, combined with an outside fixating feature that then squeezes the flexible tubing into a mechanically locked/fixated assembly.

Another method of connecting flexible tubing to an injection molded product is to weld or glue the flexible tubing in place if the two materials in contact are chemically bondable in case of welding, and alternatively, have a glue that can bond sufficiently to both materials in the glueing/contact areas.

In addition to the above-mentioned attachment/connection solutions, attempts have been made to insert and overmold flexible tubing. Still, the inaccuracy in the extruded flexible tubing makes it very difficult to make accurate overmolding without flash or short shots, limiting the process to simple geometries and low-quality products, also limiting automated mass production.

Another problem with the current overmolding solutions for flexible tubing is the challenge of achieving both chemical bonding and mechanical bonding. The extruded flexible tubing is often made of a softer material trying to be attached to a harder material. This presents a difficulty in both chemically bonding the different materials and creating a mechanical bond.

The extruded flexible tubing has a profile without undercuts and/or protrusions, where the mechanical bond can secure a solid connection between the two materials of the part you want to assemble. This often result in a lot of expensive scrap when you pull, and/or leak test the assembled product.

Biodegradable plastics are plastics degraded by microorganisms into water, carbon dioxide (or methane), and biomass under specified conditions. To guide consumers in their decision-making and give them confidence in a plastic's biodegradability, universal standards have been implemented, new materials have been developed, and a compostable logo has been introduced.

Biodegradable plastics can be applied in a range of useful ways. They can be foamed into packing materials, extruded, and injection-molded in modified conventional machines. Different types of fillers can be used with the system, such as wood flour, lime, clay, or wastepaper. The fillers can be colored and also used in various granulation sizes to change the material's external appearance.

The material can also be combined with other plastic materials such as LDPE, PP, HDPE and other suitable materials.

In a co-extrusion process, you could, e.g., deposit a thin layer of plastic material over the top and/or other exposed areas of the biodegradable plastic and/or material. This yields a biodegradable item compared to conventional plastic materials.

Biodegradable plastics, such as bioplastics, whose components are derived from renewable raw materials, and plastics made from petrochemicals with biodegradable additives that enhance biodegradation. Biodegradable plastics offer an ideal solution in many single- or short-term use applications.

Bioabsorbable polymers degrade and disappear at predictable rates, also making them an ideal material for parts of implantable devices that could otherwise impair healing or create an ongoing risk of injury or infection.

Bioresorbable polymers, also known as bioabsorbable polymers, are synthetic materials that can be utilized in implantable medical devices for treatment and degrade over time when the scaffold is no longer required.

Bioabsorbable sutures made of glycoside/lactide polymers, first developed in the 1970s, are strong and flexible enough to hold tissue together to promote healing. But unlike synthetic sutures, which stay in the patient long after a wound has healed, bioabsorbable sutures do not create a long-term risk of foreign-body reactions or require a second intervention to remove.

Therefore, there is a need for developing a method that can solve the abovementioned challenges to make better automated solutions for the connection of extruded flexible tubing and/or foils, e.g., vacuum-formed foils, to more solid structures and/or devices.

It is apparent now that numerous methods and systems have been developed in the prior art that are adequate for various purposes. Furthermore, even though these methods may be suitable for the specific purposes to which they address, they would not be ideal for the purposes of the present invention as heretofore described. Thus, a method or a system that enables a better connection and automation possibilities between extruded flexible profiles and foils to an injection molded part.

### SUMMARY OF THE INVENTION

The present invention concerns a method of introducing at least one extruded profile or part of an extruded profile onto and/or up to at least one core part in a mold. Closing said mold around said extruded profile or part of an extruded profile, thereby creating at least one moldable cavity in said mold. Introducing molten plastic into said cavity, thereby creating an accurate connection piece onto said extruded profile or part of an extruded profile for the later assembly at the intended connection point on and/or in the intended connecting part. Thereby having created an accurate fixing point x, y, z, for an automated assembly and/or overmolding process.

Extruded flexible profiles can be produced as a single layer or in multiple layers and with combinations of materials, e.g., for light guiding cables, camera inspection, a printing surface, chemical and/or barrier properties that make it difficult to adhere/bond and/or mechanical lock in an indented contact point in an intended part assembly.

Therefore, there can be great improvements made in the later assembly and/or overmolding process by first having an extruded flexible profile overmolded with a material that is chemically compatible with at least one of the materials in the extruded profile.

In a co-extrusion process having the biodegradable material protected by a liner on the inside and/or the outside, the challenge will be at the exposed ends every time a given length is cut. Here, the invention offers an additional advantage in pre-overmolding the ends of the extruded material by scaling this area, e.g., making it waterproof and/or imparting other barrier properties to the exposed ends.

Another benefit when using flexible extruded biodegradable and/or bioabsorbable materials according to the invention is that you can create smooth finishes, bends/curves, rigid skeleton, connection points and end solutions on parts in materials that are difficult to injection mold and still be your sustainability and/or recycle criteria's as long as you keep your regular plastic spend in the overmolding under the required percentages of the finished product.

When overmolding an extruded flexible profile, it might be advantageous/preferable to over mold both ends of, e.g., a tubing piece like a water hose or medical tubing, where both ends can be bent into the mold, introducing only ends into the mold, leaving the remaining length of the tube outside the mold.

The pre-overmolding piece could also contain more than one extruded flexible profile, e.g., having more than one extruded flexible tubing for the implementation/overmolding in a following injection molded container intended to have more than one flexible tubing piece attached.

In a special version of the invention, the flexible tubing piece would contain multiple parallel canals/holes, e.g., like a double-barreled shotgun having two or more connected barrels in parallel, and here, according to the invention, the flexible tubing could have even double-digit parallel canals/holes in the same piece of flexible tubing.

In another version, according to the invention, the tubing could be configured to have multiple tubes combined in one fixture for connection in one end and separate single or multiple fixtures at the other end, e.g., two tubes molded together in one fixture, separating out to two singles in the other end.

The pre-overmolding invention could ensure a much smaller pitch between the flexible tubing canals/holes and enable much smaller fluid devices, and thereby open new possibilities for micro molding and how microfluid devices are connected to other medical applications.

In another special version of the invention, at least a part of the metal core piece of the pre overmolding station is transferred along with the extruded flexible tubing length to a following overmolding station.

In another special version of the invention, a flexible wire, preferably of metal, is introduced into the hollow flexible tubing serving as a core piece during the overmolding, enabling a shot off on a flexible hollow profile during the overmolding process, creating, e.g., a skeleton structure that could keep the tubing in a 180-degree curve after the overmolding.

The flexible core piece is then pulled out from the extruded flexible tubing and this is preferably done while the flexible tubing is still in the overmolding station.

For medical tubing, the method according to the invention can be very advantageous/preferable, especially for flexible tubing that goes into the body, e.g., through blood vessels or catheters that go into the urine tract, where small or even micro holes are used to deliver and/or empty fluids or devices.

Here the accuracy is extremely important and the method according to the invention and ensure a smooth transition between the extruded tubing with the pre molding attached and the more complex geometry of a following overmolding where e.g. micro features like holes and canals could be part of the finished product.

Overmolding extruded flexible tubing parts can be very difficult, given the limited accuracy in the extrusion process, which makes it difficult to position accurately in the mold and hard to have a repeatedly accurate shot volume in the cavity where the overmolding takes place.

Therefore, the production yield can be improved by using, e.g., the P&G iMFLUX technology that controls the material injection into the mold in real-time in a closed-loop feedback that maintains a constant low pressure and also compensates for material viscosity and shot weight variations in real-time, enabling a more uniform manufacturing process. This results in fewer flashes and shorter shots in your insert overmolding process, leading to better products and less scrap.

Having an accurate injection molded reference point/area on the extruded flexible tubing part enables a following automated manufacturing process of complex geometry and micro features e.g. catheters that goes into the urine tract where the extruded catheter body potentially of biodegradable material that normally couldn't be used for catheters now could be supplied with an connecting feature at the bottom and a smooth entry point e.g. with small micro holes and/or through holes in general on the side and/or in front and/or back helping the emptying process of the bladder.

Micro fluid devices could also benefit from the present invention where connecting flexible tubing is needed given their small footprint and often very proximity of entry and exit connection points e.g. by making an easy connectable harness of flexible tubing that could connect to a pump and/or a disposable micro fluid device that connected to the expensive equipment needed to operate and read the result of the biologic sample processed in the disposable micro fluid device.

The pre-over mold material could also have additives like metal powder serving as a detection marker when introducing tubing and/or delivery tubing into, e.g., a blood vein going to the heart for a medical procedure to help a product release and/or surgical interaction.

Here, the profile that is overmolded with a material/compound capable of serving as a detection marker capable of being detected by a contactless detection device, e.g., an ultrasound scanner, a CT scanner, or an MRI scanner, determines the position of the extruded flexible profile by detecting the position of the marker.

The extruded flexible profiles intended for overmolding could consist of more than one layer, e.g., multi-material for barrier and/or chemical properties, and/or a coating applied after the extrusion process. This could e.g. be for barrier, biologic interaction, hydrophobic, hydroscopic and/or combinations of these.

The extruded flexible tubing could be for emptying, removing, moving, delivering, and controlling fluids, e.g., fluidics involving the use of fluidic pumps, which employ valves that have few or no moving parts, and/or providing medical products and/or medical devices.

Having a precision injection-molded finish at the front and/or the end of the extruded flexible tubing opens up tremendous new possibilities in the accuracy of medical procedures conducted through extruded flexible tubing, including the delivery, entry, and/or exit of medical devices through the hollow tubing.

Welded flexible bags for fluids from extruded flexible foils and sheets in both single and multilayer are often used in the medical industry, where PVC and EVA are some of the chosen grades due to their good welding properties that enable an easy connection of fitments, connectors, and other attachments.

In another special version of the invention, the overmolding can be used as a means of assembly, molding the flexible foil together and/or a thermoformed container piece instead, and/or in support of a welding process. An additional mechanical bond can be achieved if holes are made through the foils, emulating stitches, when the overmolding material flows through the holes and around the combined edges of the foils intended for assembly and/or welding.

Improved results can also be achieved when at least one layer and/or area of the inserted extruded multi-layer flexible profile and/or foil intended for overmolding can chemically bond to the material introduced into the mold during the overmolding process, in part or in full.

Fitment and/or other pre-molded pieces could also be overmolded onto extruded foils and/or flexible extruded tubing and profiles, creating assemblies that now could be more rigid and in materials that are hard to weld and/or biodegradable materials. Using multilayer foils and/or tubing enables new possibilities for chemical and/or mechanical connections, also providing the option of controlled peeling strength for separating materials for recycling.

In yet another version of the invention, a rigid skeleton could be molded on to a multilayer extruded flexible foil piece, creating e.g. a container or a housing structure with unique barrier and/or recycling capabilities, where a controlled separation force e.g. by material selection in the extruded multilayer foil and where recyclable, regular or compounded skeleton material also could be a product feature.

The percentage of recyclable skeleton material could be more than 5%, 10%, 15%, 20%, 25%, 30%, 35%, 40%, 45%, 50%, 55%, 60%, 65%, 70%, 75%, 80%, 85%, 90%, 95% up to 100%.

Currently most standard closures and fitments with good sealing properties are made from relative rigged polyolefins that has limited welding and attachment options to PVC and EVA materials. Still, the current invention aims to remedy this through the overmolding process, which, through a multilayer extrusion process of the flexible product, can incorporate a variety of other materials with enhanced strength and barrier properties, as well as additional options for recyclability.

A solution with LIM liquid silicone molding could also be a possibility as an overmolding step where the curing of the silicone was part of the process.

### BRIEF DESCRIPTION OF DRAWINGS

The accompanying drawings illustrate various embodiments of systems, methods, and other aspects of the disclosure. Any person with ordinary skills in the art will appreciate that the illustrated element boundaries (e.g. boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another and vice versa.

Furthermore, elements may not be drawn to scale. Non-limiting and non-exhaustive descriptions are described with reference to the following drawings. The components in the figures are not necessarily to scale, emphasis instead being placed upon illustrating principles. Furthermore, the drawings may contain text or captions that may explain certain embodiments of the present invention. This text is included for illustrative, non-limiting, explanatory purposes of certain embodiments detailed in the present invention. In the drawings:

Embodiments of the invention are described with reference to the following figures. The same numbers are used throughout the figures to reference like features and components. The features depicted in the figures are not necessarily shown to scale. Certain features of the embodiments may be shown exaggerated in scale or in somewhat schematic form, and some details of elements may not be shown in the interest of clarity and conciseness.

FIG. 1 illustrates an extrusion machine for making flexible tubing for the following insert and overmolding procedure of flexible tubing in accordance with the present invention.

FIG. 2 illustrates an injection molding machine that can receive a flexible tubing for an insert and an overmolding procedure of flexible tubing in accordance with the present invention.

FIG. 3 illustrates a top view of a skeleton structure molded onto a multilayer extruded foil in accordance with the present invention.

FIG. 4 illustrates a section piece of a double through hole flexible tube extruded profile accordance with the present invention.

FIG. 5 illustrates a section piece of a double through hole flexible tube extruded profile from another angle than FIG. 4, in accordance with the present invention.

FIG. 6 illustrates an injection mold for conducting an overmolding procedure on an insert piece of long extruded flexible tubing in accordance with the present invention.

### DETAILED DESCRIPTION OF THE INVENTION

The present specification is directed towards multiple embodiments. The following disclosure is provided to enable a person of ordinary skill in the art to practice the invention. Language used in this specification should not be interpreted as a general disavowal of any one specific embodiment or used to limit the claims beyond the meaning of the terms used therein. The general principles defined herein may be applied to other embodiments and applications without departing from the spirit and scope of the invention. Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For purpose of clarity, details relating to technical material that is known in the technical fields related to the invention have not been described in detail so as not to unnecessarily obscure the present invention.

In the description and claims of the application, each of the words “units” represents the dimension in any units such as centimeters, meters, inches, feet, millimeters, micrometers, and the like, and forms thereof, are not necessarily limited to members in a list with which the words may be associated.

In the description and claims of the application, each of the words “comprise”, “include”, “have”, “contain”, and forms thereof, is not necessarily limited to members in a list with which the words may be associated. Thus, they are intended to be equivalent in meaning and be open-ended in that an item or items following any one of these words is not meant to be an exhaustive listing of such item or items, or meant to be limited to only the listed item or items. It should be noted herein that any feature or component described in association with a specific embodiment may be used and implemented with any other embodiment unless clearly indicated otherwise.

Regarding applicability of 35 U.S.C. § 112, 96, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denote “at least one,” but do not exclude a plurality unless the contextual use dictates otherwise. When used herein to join a list of items, “or” denotes “at least one of the items,” but does not exclude a plurality of items from the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the scope of the disclosure. Instead, the proper scope of the disclosure is defined by the appended claims. The present invention contains headers. It should be understood that these headers are used as references and are not to be construed as limiting the subject matter disclosed under the header.

This specification includes references to “one embodiment” or “an embodiment.” The use of phrases such as “in one embodiment” or “in an embodiment” does not necessarily refer to the same embodiment. Particular features, structures, or characteristics may be combined in any suitable manner consistent with this disclosure.

The presence of broadening words and phrases such as “one or more,” “at least,” “but not limited to” or other like phrases in some instances shall not be read to mean that the narrower case is intended or required in instances where such broadening phrases may be absent.

It must also be noted that as used herein and in the appended claims, the singular forms “a,” “an,” and “the” include plural references unless the context dictates otherwise. Although any systems and methods similar or equivalent to those described herein can be used in the practice or testing of embodiments of the present disclosure, the preferred systems and methods are now described.

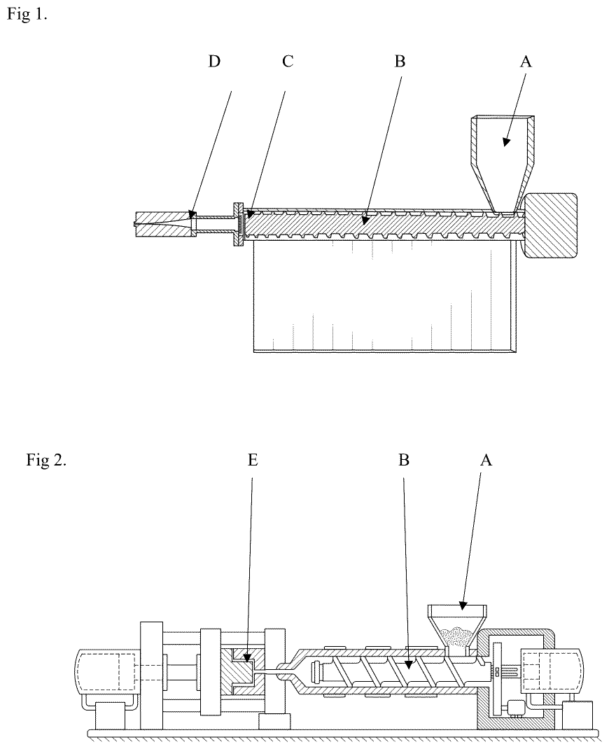

FIG. 1 illustrates an extrusion machine having A, a hopper for extrusion material and B, a screw for mixing the material and moving it forward towards C, the breaker plate, before entering D, the open-ended tube extrusion die for making flexible tubing for a following insert and overmolding procedure of flexible tubing in accordance with the present invention.

FIG. 2 illustrates an injection molding machine having A, a hopper for injection molding materiel B, a screw for mixing the material and moving it forward towards the injection chamber E, whereafter the screw B, moves forward in a linier movement injecting the molten material into the injection mold F, that over mold the introduced extruded flexible tubing in full or in part in an overmolding procedure of flexible tubing in in accordance with the present invention.

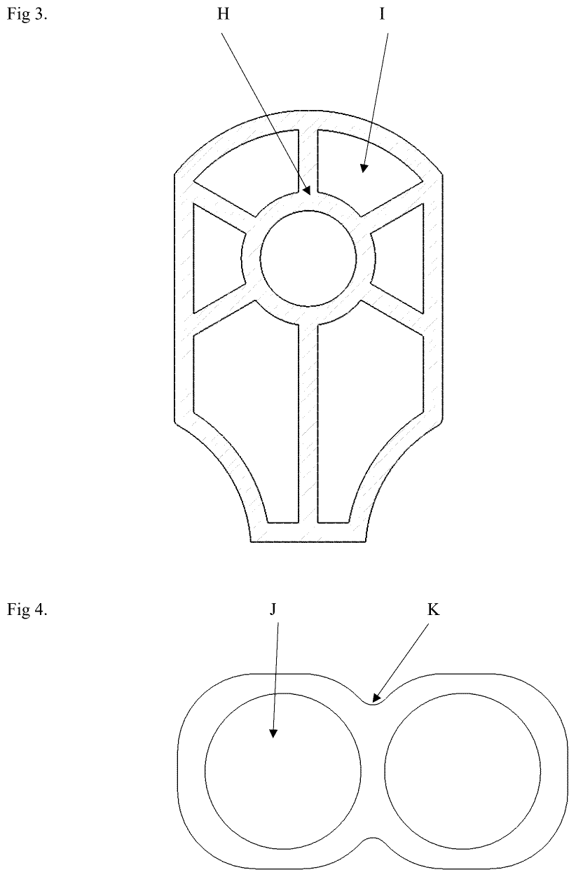

FIG. 3 illustrates a top view of a colostomy bag H, with a skeleton structure I, molded onto a multilayer extruded foil in accordance with the present invention.

FIG. 4 illustrates a section of a double through-hole J in a flexible tube extruded profile K, in accordance with the present invention.

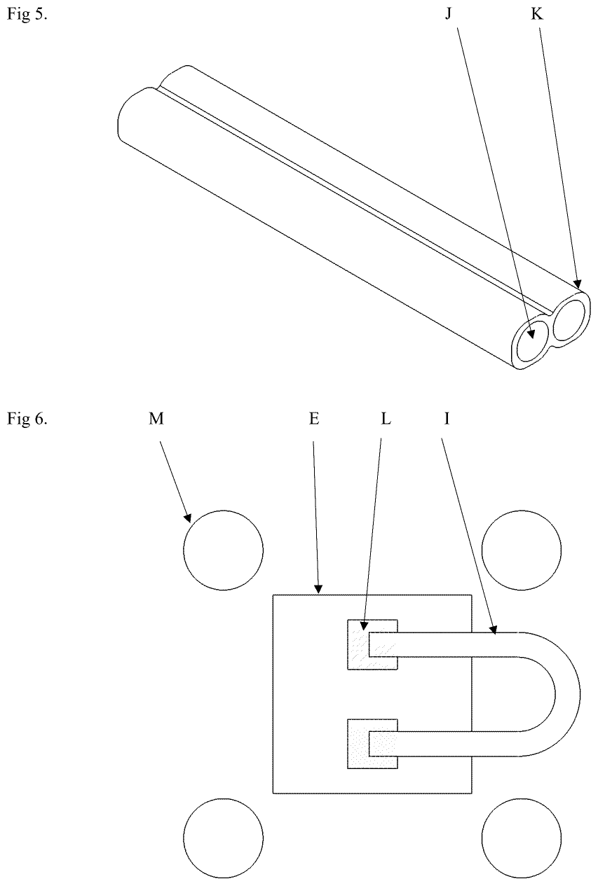

FIG. 5 illustrates a section piece of a double through hole J, of a flexible tube extruded profile K, from another angle than FIG. 4, in accordance with the present invention.

FIG. 6 illustrates an injection mold E. sitting between the tie bars M, of the injection molding machine for conducting an overmolding procedure on an insert piece of a long extruded flexible tubing I, having part of the tubing sticking outside the mold but having both end pieces positioned in the mold cavity L, in accordance with the present invention.

While illustrative implementations of the application have been described in detail herein, it is to be understood that the inventive concepts may be otherwise variously embodied and employed, and that the appended claims are intended to be construed to include such variations, except as limited by the prior art.

Throughout this specification, references to “one implementation” or “an implementation” indicate that a particular feature, structure, or characteristic described in connection with the implementation is included in at least one implementation of the present invention. Thus, the appearances of the phrases “in one implementation” or “in some implementations” in various places throughout this specification do not necessarily refer to the same implementation. Furthermore, the particular features, structures, or characteristics may be combined in any suitable manner in one or more implementations.

Systems and methods describing the present invention have been described. It will be understood that the descriptions of some embodiments of the present invention do not limit the various alternative, modified, and equivalent embodiments which may be included within the spirit and scope of the present invention as defined by the appended claims. Furthermore, in the detailed description above, numerous specific details are provided to facilitate an understanding of various embodiments of the present invention. However, some embodiments of the present invention may be practiced without these specific details. In other instances, well-known methods, procedures, and components have not been described in detail so as not to unnecessarily obscure aspects of the present embodiments.

1. A method of introducing at least one extruded flexible product or part of an extruded flexible product into a cavity in a mold, including the steps of
closing said mold around said extruded product or part of said extruded profile thereby creating at least one moldable cavity area in said mold; and
introducing molten plastic and/or curable resin into said cavity thereby creating/molding an accurate fixing/placement connection piece onto said extruded flexible product or part of said extruded flexible product for the later assembly at the intended connection point on and/or in the intended connecting part;
thereby having created an accurate fixing/placement point of said part for a following automated assembly and/or over molding process of the extruded product.

2. The method as in claim 1, wherein variation in shot wait is maintained by controlling the material injection into the mold real-time in closed-loop feedback that maintains low constant pressure and also compensate for material viscosity and shot weight variations real-time enabling a more uniform manufacturing process e.g. the iMFLUX molding technology from P&G.

3. The method as in claim 1, wherein the inserted extruded flexible product intended for over molding consist of more than one layer e.g. multi material for barrier and/or chemical properties and/or a coating applied after extrusion process.

4. The method as in claim 1, wherein the area of the inserted extruded flexible profile that is over molded with a material/compound capable of serving as a detection marker capable of being detected by a contactless detection devise like e.g. an ultrasound scanner, a CT scanner or MRI scanner determining the position of the extruded flexible profile by detecting the position of the marker.

5. The method as in claim 1, wherein both ends of the inserted extruded flexible profile intended for over molding gets over molded in cavities in the same mold in the same molding cycle.

6. The method as in claim 1, wherein at least the area of the inserted extruded flexible profile intended for over molding have been coated for better chemical bonding to the introduced over molding material.

7. The method as in claim 1, wherein the area of the inserted extruded flexible product intended for over molding have been modified/reworked after extrusion to have holes and/or anchoring features for better mechanical and/or chemical retention in the introduced over molding material.

8. The method as in claim 1, where the inserted extruded flexible product intended for over molding is biodegradable and/or recyclable in full or in part.

9. The method as in claim 1, where the over molding material is made of a ridged material acting as a skeleton strengthening and/or fixation keeping the extruded flexible product in a fixed or relative fixed position e.g. an extruded tubing piece bend in a 180-degree position and kept so by the rigid material after over molding.

10. The method as in claim 1, wherein the area of the inserted extruded flexible profile intended for over molding has at least one through hole that goes through the full length of the extruded profile.

11. The method as in claim 1, wherein the area of the inserted extruded flexible profile intended for over molding have had at least one through hole made that goes through the diameter wall of the extruded profile.

12. The method as in claim 1, wherein the area of the inserted extruded multi-layer flexible profile and/or foil intended for over molding have had at least one layer removed in part or in full in the area indented for over molding.

13. The method as in claim 1, wherein the area of the inserted extruded flexible profile and/or foils intended for over molding is over molded with a fitment e.g. a closure, an undercut, a sleave or a treated connection like nuts and/or bolts at one or more areas of the flexible profile.

14. The method as in claim 1, wherein the area of the inserted extruded flexible profile intended for over molding has at least one through hole that goes through the full length of the extruded profile.

15. The method as in claim 1, wherein the area of the inserted extruded flexible foils intended for over molding molds the foils and/or thermoformed foils together chemically and/or mechanically.

16. The method as in claim 1, wherein the area of the inserted extruded flexible profile intended for over molding is over molded with at least 80% biodegradable and/or recyclable material.

17. The method as in claim 1, wherein the area of the inserted extruded flexible profile intended for over molding is over molded with less than 20% non-biodegradable and/or non-recyclable material.

18. The method as in claim 1, wherein at least one layer and/or area of the inserted extruded multi-layer flexible profile and/or foil intended for over molding can chemically bond to the material introduced into the mold during the over molding process in part or in full.

19. The method as in claim 1, wherein at least one layer and/or area in part or in full of the inserted extruded multi-layer flexible profile and/or foil intended for over molding have a controlled pealing strength predetermined by the adhesion layer in the multi-layer foils and/or in the over molding material in part or in full.

20. The method as in claim 1, wherein at least one layer and/or area in part or in full of the inserted extruded multi-layer flexible profile and/or foil intended for over molding having LIM liquid silicone molding as an over molding step where a curing of the silicone is part of the process.
